(19) United States
(12) Patent Application Publication
(10) Pub. No.: US 2008/0199755 A1
(43) Pub. Date: Aug. 21, 2008

(54) CONDUCTIVE POLYMERS

(76) Inventors: Ian David Brotherston, Malvern (GB); John Lindley Bancroft, Tarporley (GB)

Correspondence Address: KING & SCHICKLI, PLLC, 247 NORTH BROADWAY, LEXINGTON, KY, 40507, US

(21) Appl. No.: 12/049,590

(22) Filed: Mar. 17, 2008

Related U.S. Application Data
(63) Continuation of application No. PCT/US2006/003450, filed on Sep. 17, 2005.

(30) Foreign Application Priority Data
Sep. 17, 2005 (GB) 0519045.9

(51) Int. Cl. H01M 8/10; H01B 1/04

(52) U.S. Cl. 429/33; 252/62.2; 252/500

(57) ABSTRACT

There is provided a solid ionically conductive polymer having repeat units of a quaternary ammonium and including a plasticiser in an amount sufficient to render the polymer non-crystalline thereby increasing conductivity.

This application is a continuation of PCT Application PCT/US2006/003450, filed Sep. 18, 2006, which claims the benefit of British Patent Application Ser. No. 0519045.9, filed Sep. 17, 2005, the disclosures of which are incorporated herein by reference.

### FIELD OF THE INVENTION

This invention relates to solid ionically conductive polymers, structures and fuel cells incorporating same, and associated methods of production and use.

### BACKGROUND OF THE INVENTION

There is much interest in the manufacture and use of conductive polymers. A wide range of ionically conductive polymers are known, with possibly the most famous example being Nafion®. Nafion® is a conductive membrane that conducts via cation conduction. Whilst Nafion® has achieved significant commercial success, there are problems associated with the material. In particular, Nafion® can only achieve useful conductivities in a swollen, hydrated state in which the material achieves volumes approximately 10 times greater than the volume associated with its unhydrated state. Thus, Nafion® membranes require constant hydration in order to function as conductive membranes and cannot operate conductively at high temperatures, e.g., at greater than 100° C.

International publications WO00/06610, WO00/06533, WO00/06658, WO01136510, WO01/40874 and WO01/74919, the contents of all of which are herein incorporated by reference, disclose a class of polymers obtained from the polymerisation of a number of compounds which possess one or more dienyl end groups. The polymers possess or promise a variety of useful and exciting properties, one of which was thought to be conductivity. However, further investigations have revealed that the conductivities of the polymers disclosed in these documents are not optimal ones. In fact, the present inventors have found that large increases in the conductivities of various polymers including polymers of the type generically disclosed in the above mentioned International publications is possible.

### SUMMARY OF THE INVENTION

Accordingly, the present invention, in at least some of its embodiments, provides improvements to the prior art conductive polymers discussed above. Furthermore, the present invention can provide advantageous ways of applying conductive polymers and provides a class of conductive polymers that conduct by anionic conduction.

According to a first aspect of the invention there is provided a solid ionically conductive polymer having repeat units of a quaternary ammonium and including a plasticiser in an amount sufficient to render the polymer non-crystalline thereby increasing conductivity.

### DETAILED DESCRIPTION OF THE INVENTION

Conductivities comparable to that of Nafion® can be achieved without requiring hydration. Without wishing to be bound by any theory, it is believed that departure from crystallinity increases the efficiency of ion transfer between repeat units.

The plasticiser may be present as an additive to the polymer. A preferred plasticiser of this sort is propylene carbonate. The polymer may contain between 5 and 60% by weight plasticiser additive. In order to produce polymers with reasonable mechanical strength, it is preferred that the polymer contains between 5 and 30% by weight plasticiser additive. For higher conductivities, the polymer may contain between 25 and 60% by weight plasticiser additive. In general, polymers of this type exhibit somewhat poorer mechanical properties, but this may be acceptable or even desirable in certain applications. In some instances the polymer may contain more than 60% by weight plastic additive. Alternatively the polymer may be self-plasticising. The polymer can be self-plasticising in numerous ways. This polymer may include an anion present as a counterion to the quaternary ammonium, and the anion may act as a plasticiser. In alternative embodiments the quaternary ammonium itself acts as a self-plasticiser. In general larger anions and/or cationic quaternary ammoniums render the polymer less likely to adopt a crystalline configuration.

The polymer may contain a plurality of different plasticisers.

The polymer may conduct by anionic conduction. It has been found that it is possible to provide anionically conducting polymers which exhibit conductivity comparable to H⁺ conducting membranes. Alternatively, the polymer may conduct by cationic conduction, which may be proton conduction.

Advantageously, the polymer is formed from the polymerisation of a monomer which comprises a group of sub-formula (I)

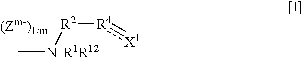

where R² and R³ are independently selected from (CR⁷R⁸)ₙ, or a group CR⁹R¹⁰, CR⁷R⁸CR⁹R¹⁰ or CR⁹R¹⁰CR⁷R⁸ where n is 0, 1 or 2, R⁷ and R⁸ are independently selected from hydrogen, halo or hydrocarbyl, and either one of R⁹ or R¹⁰ is hydrogen and the other is an electron withdrawing group, or R⁹ and R¹⁰ together form an electron withdrawing group, and
R⁴ and R⁵ are independently selected from CH or CR¹¹ where R¹¹ is an electron withdrawing group;
the dotted fines indicate the presence or absence of a bond, X¹ is a group CX²X³ where the dotted line bond to which it is attached is absent and a group CX² where the doted line bond to which it is attached is present, Y¹ is a group CY²Y³ where the dotted line bond to which it is attached is absent and a group CY² where the dotted line bond to which it is attached is present, and X², X³, Y² and Y³ are independently selected from hydrogen, fluorine or other substituents;

R¹ is selected from hydrogen, halo, nitro or hydrocarbyl, optionally substituted or interposed with functional groups;

R¹² is selected from hydrogen, halo, nitro, hydrocarbyl, optionally substituted or interposed with functional groups, or —R³—R⁵ [symbol] and

Z is an anion of charge m.

Preferably, the polymer is formed from the polymerisation of a dienyl quaternary ammonium, most preferably from polymerisation of a starting material which comprises a group of sub-formula (II)

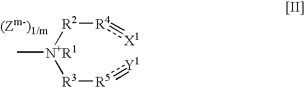

where R² and R³ are independently selected from (CR⁷R⁸)ₙ, or a group CR⁹R¹⁰, CR⁷R⁸CR⁹R¹⁰ or CR⁹R¹⁰CR⁷R⁸ where n is 0, 1 or 2, R⁷ and R⁸ are independently selected from hydrogen, halo or hydrocarbyl, and either one of R⁹ or R¹⁰ is hydrogen and the other is an electron withdrawing group, or R⁹ and R¹⁰ together form an electron withdrawing group, and

R⁴ and R⁵ are independently selected from CH or CR¹¹ where R¹¹ is an electron withdrawing group;

the dotted lines indicate the presence or absence of a bond, X¹ is a group CX²X³ where the dotted line bond to which it is attached is absent and a group CX² where the dotted line bond to which it is attached is present, Y¹ is a group CY²Y³ where the dotted line bond to which it is attached is absent and a group CY₂ where the dotted line bond to which it is attached is present, and X², X³, Y² and Y³ are independently selected from hydrogen and fluorine;

and R¹ is hydrogen or hydrocarbyl, and Z is an anion of charge m.

As used herein, the expression “in the substantial absence of solvent” means that there is either no solvent present or there is insufficient solvent present to completely dissolve the reagents, although a small amount of a diluent may be present to allow the reagents to flow.

Conditions under which polymerisation occurs include the influence of radiation or an electron beam, heat or the presence of a chemical initiator. Radiation or electron beam induced polymerisation is suitably effected in the substantial absence of a solvent.

Preferably, R⁷ and R³ are independently selected from fluoro, chloro, alkyl or H. In the case of alkyl, methyl is most preferred.

It is possible that at least one, and possibly all, of X², X³, Y² and Y³ is a substituent other than hydrogen or fluorine. Preferably at least one, and possibly all, of X², X³, Y² and Y³ is an optionally substituted hydrocarbyl group. In such embodiments, it is preferred that at least one, and most preferably all, of X², X³, Y² and Y³ is an optionally substituted alkyl group. Particularly preferred examples are C₁ and C₄ alkyl groups, especially methyl or ethyl. Alternatively, at least one, and preferably all, of X², X³, Y² and Y³ are aryl and/or heterocyclic, such as pyridyl, pyrimidinyl, or a pyridine or pyrimidine containing group.

In preferred embodiments, X¹ and Y¹ are groups CX²X³ and CY¹Y² respectively and the dotted lines represent an absence of a bond. Thus preferred compounds are those of sub-formula (IA)

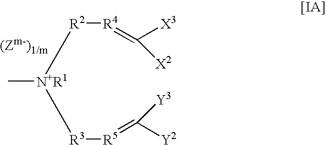

where R¹, R², R³, R⁴, R⁵, R⁶, X², X³, Y² and Y³ are as defined above. One or more such starting materials may be polymerised together. When more than one starting material is used, a copolymer will result.

When the dotted bonds in sub formula (I) are present, the resulting polymer will comprise polyacetylene chains. This can lead to a conjugated system with the possibility of associated conductivity.

Suitably the starting material is one which will cyclopolymerise in the sort of conditions used in polymer production. This may comprise the application of radiation, such as UV radiation, where necessary in the presence of a photoinitiator, the application of heat (which may be in form of IR radiation), where necessary in the presence of an initiator, by the application of other sorts of initiator such as chemical initiators, or by initiation using an electron beam. The expression “chemical initiator” as used herein refers to compounds which can initiate polymerisation such as free radical initiators and ion initiators such as cationic or anionic initiators as are understood in the art.

Preferably, the starting materials polymerise under the influence of ultraviolet radiation or thermal radiation or both. Cyclopolymerisation may take place either spontaneously or in the presence of a suitable initiator. Examples of suitable initiators include 2,2′-azobisisobutyronitrile (AIBN), aromatic ketones such as benzophenones in particular acetophenone; chlorinated acetophenones such as di- or tri-chloracetophenone; dialkoxyacetophenones such as dimethoxyacetophenones (sold under the trade name “Irgacure 651”) dialkylhydroxyacetophenones such as dimethylhydroxyacetophenone (sold under the trade name “Darocure 1173”); substituted dialkylhydroxyacetophenone alkyl ethers such as compounds of formula

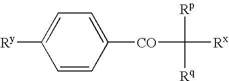

where R^{y} is alkyl and in particular 2,2-dimethylethyl, R^{x} is hydroxyl or halogen such as chloro, and R^{p} and R^{q} are independently selected from alkyl or halogen such as chloro (examples of which are sold under the trade names “Darocure 1116” and “Trigonal P1”); 1-benzoylcyclohexanol-2 (sold under the trade name “Irgacure 184”); benzoin or derivatives such as benzoin acetate, benzoin alkyl ethers in particular benzoin butyl ether, dialkoxybenzoins such as dimethoxybenzoin or deoxybenzoin; dibenzyl ketone; acyloxime esters such as methyl or ethyl esters of acyloxime (sold under the trade name “Quantaqure PDO”); acylphosphine oxides, acylphosphonates such as dialkylacylphosphonate, ketosulphides for example of formula

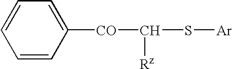

where R^{z} is alkyl and Ar is an aryl group; dibenzoyl disulphides such as 4,4′-dialkylbenzoyldisuphide; diphenyldithiocarbonate; benzophenone; 4,4′-bis(N, N-dialkyamino) benzophenone; fluorenone; thioxanthone; benzil; or a compound of formula

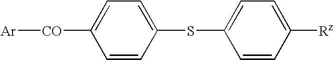

where Ar is an aryl group such as phenyl and R^{z} is alkyl such as methyl (sold under the trade name “Speedcure BMDS”).

As used herein, the term “alkyl” refers to straight or branched chain alkyl groups, suitably containing up to 20 and preferably up to 6 carbon atoms. The term “alkenyl” and “alkynyl” refer to unsaturated straight or branched chains which include for example from 2-20 carbon atoms, for example from 2 to 6 carbon atoms. Chains may include one or more double to triple bonds respectively. In addition, the term “aryl” refers to aromatic groups such as phenyl or naphthyl.

The term “hydrocarbyl” refers to any structure comprising carbon and hydrogen atoms. For example, these may be alkyl, alkenyl, alkynyl, aryl such as phenyl or napthyl, arylalkyl, cycloalkyl, cycloalkenyl or cycloalkynyl. Suitably they will contain up to 20 and preferably up to 10 carbon atoms. The term “heterocylyl” includes aromatic or non-aromatic rings, for example containing from 4 to 20, suitably from 5 to 10 ring atoms, at least one of which is a heteroatom such as oxygen, sulphur or nitrogen. Examples of such groups include furyl, thienyl, pyrrolyl, pyrrolidinyl, imidazolyl, triazolyl, thiazolyl, tetrazolyl, oxazolyl, isoxazolyl, pyrazolyl, pyridyl, pyrimidinyl, pyrazinyl, pyridazinyl, triazinyl, quinolinyl, isoquinolinyl, quinoxalinyl, benzthiazolyl, benzoxazolyl, benzothienyl or benzofuryl.

The term “functional group” refers to reactive groups such as halo, cyano, nitro, oxo, C(O)ₙR^{a}, OR^{a}, S(O), R^{a}, NR^{b}R^{c}, OC(C)NR^{b}R^{c}, C(O)NR^{b}R^{c}, OC(O)NR^{b}R^{c}, —NR⁷C(O)ₙR⁵, —NR^{a}CONR^{b}R^{c}, C═NOR^{a}, —N═CR^{b}R^{c}, S(O)ₜNR^{b}R^{c}, C(S)ₙR^{a}, C(S)OR^{a}, C(S)NR^{b}R^{c} or —NR^{b}S(O)ₜR^{a} where R^{a}, R^{b} and R^{c} are independently selected from hydrogen or optionally substituted hydrocarbyl, or R^{b} and R^{c} together form an optionally substituted ring which optionally contains further heteroatoms such as S(O)ₛ, oxygen and nitrogen, n is an integer of 1 or 2, t is 0 or an integer of 1-3. In particular the functional groups are groups such as halo, cyano, nitro, oxo, C(O)ₙR^{a}, OR^{a}, S(O)ₜR^{e}, NR^{b}R^{c}, OC(O)NR^{b}R^{c}, C(O)NR^{b}R^{c}, OC(O)NR^{b}R^{c}, —NR⁷C(O)NR⁶, —NR^{a}CONR^{b}R^{c}, —NR^{a}CSNR^{b}R^{c}, C═NOR^{a}, —N═CR^{b}R^{c}, S(O)ₜNR^{b}R^{c}, or —NR^{b}S(O)ₜR^{a} where R^{a}, R^{b} and R^{c}, n and t are as defined above.

The term “heteroatom” as used herein refers to non-carbon atoms such as oxygen, nitrogen or sulphur atoms. Where the nitrogen atoms are present, they will generally be present as part of an amino residue so that they will be substituted for example by hydrogen or alkyl.

The term “amide” is generally understood to refer to a group of formula C(O)NR^{a}R^{b} where R^{a} and R^{b} are hydrogen or an optionally substituted hydrocarbyl group. Similarly, the term “sulphonamide” will refer to a group of formula S(O)₂NR^{a}R^{b}.

The nature of any electron withdrawing group or groups additional to the ammonium moiety used in any particular case will depend upon its position in relation to the double bond it is required to activate, as well as the nature of any other functional groups within the compound. The term “electron withdrawing group” includes within its scope atomic substituents such as halo, e.g. fluoro, chloro and bromo.

Where R¹¹ is an electron withdrawing group, it is suitably acyl such as acetyl, nitrile or nitro.

Preferably X¹, X², Y¹ and Y² are all hydrogen.

Suitable groups R^{a} include hydrogen or methyl, in particular hydrogen.

A preferred group of polymers is of the following structure

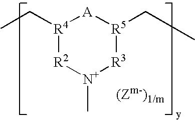

where A is a bond or CH₂, R², R³, R⁴, R⁵ and R¹ are as defined in relation to sub-formula (I) or (II), and y is an integer in excess of 1, preferably in excess of 5. The invention includes within its scope oligomers, in which instances y is typically between 2 and 15, preferably between 5 and 12. Higher molecular weight polymers are also within the scope of the invention, in which instance y can be in excess of 100.

Z^{m-} may be a halide ion, a boride ion, triflate, PF₆⁻, HSO₄⁻, H₂PO₄⁻, BF₄⁻, NO₃⁻, or a carboxylic acid ester, preferably a carboxylic acid ester having an alkyl or a per-fluorinated alkyl group of greater than five carbon atoms, most preferably octanoate or per-fluoro octanoate. Also possible are other anions having hydrocarbyl or substituted hydrocarbyl moieties. Anions having branched hydrocarbyl moieties may disrupt the formation of crystals and hence increase non-crystallinity.

In the group of sub-formula (I), X¹ and Y¹ may represent CX²X³ and CY²Y³ respectively, the dotted bonds being absent and X², X³, Y² and Y³ being all hydrogen.

The starting material may be a compound of structure (III)

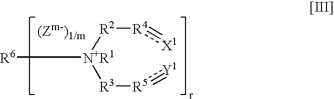

where X¹, Y¹, R², R³, R⁴, R⁵ and the dotted bonds are as defined in relation to formula (I) above, r is an integer of 1 or more, and R⁶ is a bridging group, an optionally substituted hydrocarbyl group, a perhaloalkyl group, a siloxane group or an amide, of valency r.

Where in the compound of formula (III), r is 1, compounds can be readily polymerised to form a variety of polymer types depending upon the nature of the group R⁶. Examples of groups which are commonly found in polymer technology are included below in Table 1.

Monomers of this type may be represented as structure (IV)

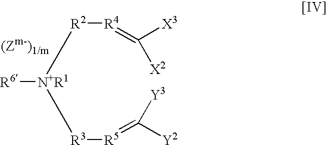

where X², X³, Y², Y³, R¹, R², R³, R⁴, and R⁵ are as defined in relation to formula (I) above, R^{6′} is an optionally substituted hydrocarbyl group, a perhaloalkyl group, a siloxane group or an amide.

The invention may also be applied to other sorts of polymers; for example, where in the compounds of formula (III), r is greater than one, polymerisation can result in polymer networks. Particular examples are compounds of formula (III) as defined above, where R⁶ is a bridging group and r is an integer of 2 or more, for example from 2 to 8 and preferably from 2-4. Embodiments in which r is two are particularly preferred.

On polymerisation of these such compounds, networks are formed whose properties maybe selected depending upon the precise nature of the R⁶ group, the amount of chain terminator present and the polymerisation conditions employed.

R¹ may be an alkyl group, preferably having less than three carbon atoms, most preferably methyl. Alternatively, R¹ may be H. Embodiments in which R¹ is H may be useful for providing proton conduction mechanisms.

In preferred structures, R⁶ or R^{6′} comprises a straight or branched chain alkyl group, optionally substituted or interposed with functional groups.

R⁶ or R^{6′} may be an optionally substituted hydrocarbyl group having four or more carbon atoms. Preferably, R⁶ or R^{6′} is an alkyl group, most preferably a straight chain alkyl group, although R⁶ or R^{6′} may be a branched chain alkyl group. R⁶ or R^{6′} may have between five and twenty carbon atoms, preferably between eight and fourteen carbon atoms, most preferably ten carbon atoms.

In particularly preferred embodiments, the starting material is a compound of formula (V)

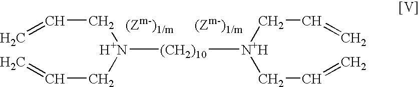

The starting material may be a compound of formula (VI)

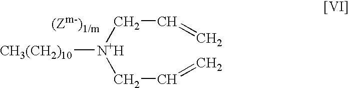

In the embodiments of formulae (v) and (vi), Z^{m-} may be PF₆⁻, per-fluoro octanoate or triflate.

R⁶ or R^{6′} may comprise a perhalo hydrocarbyl group, preferably a perfluoro hydrocarbyl group. R⁶ or R^{6′} may comprise a perhaloalkyl group such as a perfluoroalkyl group, for example of from 1 to 3 carbon atoms such as a perhalomethyl group, in particular perfluoromethyl.

R⁶ or R^{6′} may comprise a sulfonated group and/or an imidazole containing group.

Examples of suitable bridging groups include those found in polyethylenes, polypropylenes, nylons, as listed in Table 1. Further examples of bridging groups can be found in WO 00/06610.

TABLE 1

| Polymer Type | Repeat Unit of Bridging Group |
|---|---|
| Polyethylene | CH₂ |
| Polystyrene | CH₂CH(C₆H₅) where the phenyl ring is |
| | optionally substituted |
| Polyisobutylene | CH₂CH(CH(CH₃)₂) |
| Polyisoprene | CH₂CH(CH₃) |
| Polytetrafluoroethylene | CH₂(CF₂)ₓCH₂ |
| Polyvinylidenefluoride | CH₂(CF₂CH₂)ₓ |
| Polyethyleneoxide | (OCH₂CH(CH₃))ₓ0 |
| Nylon | CH₂(NHCOCH₂)ₓCH₂ |
| Peptide | CH₂(NHCOCH_{R})ₓCH₂ |
| Polyurethanes | —NH—CO—O— |
| Polyesters | —RC(O)OR′— |
| | where R and R′ are organic groups |
| | such as hydrocarbyl |
| Polysiloxanes | e.g. —SiO₂—, —R₂SiO— or |
| | —R₂Si₂O₃— where R is an organic group |
| | such as hydrocarbyl |
| Polyacrylates | —CH₂C(COOH)H— |
| Polyureas | —NHCONH— |
| Polythioureas | —NH—C(S)—NH— |

The invention includes the possibility of producing copolymers where another monomeric compound, for example one which is not of formula (I), is mixed with the compound of formula (I) prior to polymerisation. Such monomers are known in the art. Additionally or alternatively the solid ionically conductive polymer may be provided in a composite structure with one or more other materials in order to produce desired mechanical and/or electrochemical properties. The solid ionically conductive polymer may be utilised in combination with one or more inorganic materials such as SiO₂, tungsten compounds, and glass fibre.

In embodiments in which R¹² is not —R³—R⁵ [symbol] the monomer is preferably of the following formula

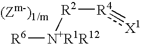

where R⁶ is as previously defined and may be a group R^{6′} as previously defined.

The solid ionically conductive polymer may be self-supporting, such as in the form of a membrane, or may be used in conjunction with a substrate. Thus, according to a second aspect of the invention there is provided a substrate and a solid ionically conductive polymer according to the first aspect of the invention located therein or thereon.

The substrate may be a solid substrate, or a structure having voids therein, such as a mesh, a web or a porous substrate. A mesh or web structure can be used to reinforce the polymer. Nylon mesh or web structures may be employed.

In embodiments in which the structure is porous, the solid ionically conductive polymer may be located in the pores of the substrate. The plasticiser may be less prone to washing out of the polymer in such structures. The structure can be produced by soaking an appropriate monomer into the pores of the substrate and polymerising in situ. The plasticiser may be present with the monomer when the polymerisation takes place.

Preferably, the substrate is a ceramic or a zeolite. In this way conductive materials can be provided which are tough, can operate at high temperatures and do not require the presence of water to conduct.

The structure may be in the form of an ionically conductive membrane. Such conductive membranes have numerous applications, such as in fuel cells.

According to a third aspect of the invention there is provided a method of producing a solid ionically conductive polymer having repeat units of a quaternary ammonium including the steps of polymerising a quaternary ammonium starting material and providing a plasticiser in the polymer present in an amount sufficient to render the polymer non-crystalline thereby increasing conductivity.

Advantageously, the quaternary ammonium starting material may be sprayed onto a target structure prior to the step of polymerising. This is an extremely effective and practical way of applying a conductive coating.

The step of polymerising may be effected by the application of radiation, where necessary in the presence of an initiator. Preferably, the polymerisation is effected by the application of ultraviolet radiation.

Alternatively, the step of polymerising may be effected by the application of heat, where necessary in the presence of an initiator.

In one embodiment the plasticiser is mixed with the starting material prior to the step of polymerising.

Alternatively, the plasticiser may be added to the polymer after or during the step of polymerising.

International Publications WO 00/06610, WO 00/06533, WO 00/06668, WO 01/40814 and WO 01/74919 disclose the preparation of monomers and polymers of the dienyl type. International Publication WO 01/74919 also discloses the preparation of monomers and polymers formed from quaternary ammonium species having a single vinyl type group.

According to a fourth aspect of the invention there is provided a method of producing a structure including the steps of providing a porous substrate, introducing a quaternary ammonium starting material and a plasticiser into the pores of the substrate, and polymerising the starting material to produce a solid ionically conductive polymer, the plasticiser being present in an amount sufficient to render the polymer non-crystalline thereby increasing conductivity.

According to a fifth aspect of the invention there is provided a fuel cell including a solid ionically conductive polymer according to the first aspect of the invention. The fuel cell may include an ionically conductive membrane as described in respect of the second aspect of the invention, preferably a proton conductive membrane.

Whilst the invention has been described above, it extends to any inventive combination or sub-combination of the features set out above or in the following description or claims.

### EXAMPLE 1

The target molecule 1 is shown below.

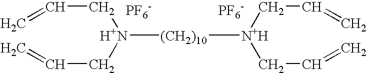

A mixture of 1,10-dibromodecane (23.8 g), diallylamine (15.4 g) and K₂CO₃ (58.0 g) in absolute ethanol were refluxed overnight with a drying arm over the condenser. Reaction progress was checked using TLC. Solid KBr and excess K₂CO₃ were removed from the solvent by filtration. Ethanol was removed by rotary evaporation together with any remaining diallylamine. Any sold KBr appearing at this point in the synthesis can be dissolved in dichloromethane (DCM) and filtered. Monomers obtained using dry silica gel flushed through with dry DCM. To a solution of monomer in methanol or dry DCM, a 6M aqueous solution of hydroperfluoric acid (HPF₈) is added until the mixture reaches a pH of about 5-6. The water is allowed to evaporate, leaving a quaternary ammonium.

### EXAMPLE 2

To the quaternary ammonium 1 prepared in Example 1, propylene carbonate and 3 wt % of Irgacure 184 photoinitiator was added, dissolved by gentle heating (at ca. ° C.) and mixing using a whilimixer. Various amounts of propylene carbonate were added in different experiments, but mixtures having between 25 and 60% by weight of propylene carbonate were found to provide the best results.

The mixture was cured by exposure to UV radiation. Exposure times depend on the UV radiation source and exposure conditions: in this instance exposure involved two passes each of ˜1 sec to a 600 W/cm Ga doped mercury UV source. The polymer thus formed was found to be conductive.

### EXAMPLE 3

The mixture of quaternary ammonium 1, photoinitator and propylene carbonate prepared in Example 2 was added to a zeolite and polymerised in situ by exposure to UV radiation. The zeolite exhibited conductivity.

### EXAMPLE 4

An analogue of the target molecule 1 was prepared in which the anion is per-fluoro octanoate. The analogue was prepared using the method described in Example 1, except that aqueous perfluorooctanoic acid was used instead of hydroperfluoric acid. The analogue was polymerised using the methodology of Example 2, and the resulting polymer exhibited a marginally higher conductivity than the polymer of Example 2.

### EXAMPLE 5

An analogue of the target molecule 1 was prepared in which the anion is triflate. The analogue was prepared using the method described in Example 1, except that triflic acid (CF₃SO₃H) was used instead of hydroperfluoric acid. The analogue was polymerised using the methodology of Example 2, and the resulting polymer exhibited a marginally higher conductivity than the polymer of Example 2.

The reaction scheme of bromoalkane, diallylamine and K₂CO₃ is a general one that can be used to prepare monomers for subsequent polymerisation and use according to the invention. Bisubstituted bromoalkanes (particularly where the bromo substitution is at either end of the alkyl chain) are used to produce monomers having two dienyl end groups. Singly substituted bromo alkanes are used to produce monomers having one dienyl end group.

1. A solid ionically conductive polymer having repeat units of a quaternary ammonium and including a plasticiser in an amount sufficient to render the polymer non-crystalline thereby increasing conductivity.

2. A solid ionically conductive polymer according to claim 1 in which the plasticiser is present as an additive to the polymer.

3. A solid ionically conductive polymer according to claim 2 in which the plasticiser is propylene carbonate.

4. A solid ionically conductive polymer according to claim 1 in which the polymer is self-plasticising.

5. A solid ionically conductive polymer according to claim 4 in which the polymer includes an anion present as a counterion to the quaternary ammonium, and the anion itself acts as a plasticiser.

6. A solid ionically conductive polymer according to claim 4 in which the quaternary ammonium itself acts as a self-plasticiser.

7. A solid ionically conductive polymer according to claim 1 which conducts by anionic conduction.

8. A solid ionically conductive polymer according to claim 1 which conducts by cationic conduction.

9. A solid ionically conductive polymer according to claim 8 which conducts by proton conduction.

10. A solid ionically conductive polymer according to claim 1 in which the polymer is formed from the polymerisation of a dienyl quaternary ammonium.

11. A solid ionically conductive polymer according to claim 10 in which the polymer is formed from polymerisation of a starting material which comprises a group of sub-formula (I) 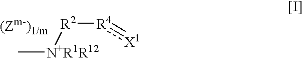
where R² and R³ are independently selected from (CR⁷R⁸)ₙ, or a group CR⁹R¹⁰, CR⁷R⁸CR⁹R¹⁰ or CR⁹R¹⁰CR⁷R⁸ where n is 0, 1 or 2, R⁷ and R⁸ are independently selected from hydrogen, halo or hydrocarbyl, and either one of R⁹ or R¹⁰ is hydrogen and the other is an electron withdrawing group, or R⁹ and R¹⁰ together form an electron withdrawing group, and
R⁴ and R⁵ are independently selected from CH or CR¹¹ where R¹¹ is an electron withdrawing group;
the dotted lines indicate the presence or absence of a bond, X¹ is a group CX²X³ where the dotted line bond to which it is attached is absent and a group CX² where the dotted line bond to which it is attached is present, Y¹ is a group CY²Y³ where the dotted line bond to which it is attached is absent and a group CY² where the dotted line bond to which it is attached is present, and X², X³, Y² and Y³ are independently selected from hydrogen, fluorine or other substituents;
R¹ is selected from hydrogen, halo, nitro or hydrocarbyl, optionally substituted or interposed with functional groups;
R¹² is selected from hydrogen, halo, nitro, hydrocarbyl, optionally substituted or interposed with functional groups, or —R³—R⁵ [symbol] and
Z is an anion of charge m.

12. A solid ionically conductive polymer according to claim 11 in which the polymer is formed from polymerisation of a starting material which comprises a group of sub formula (II) 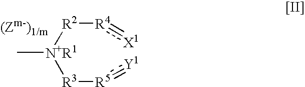
where R² and R³ are independently selected from (CR⁷R⁸)ₙ, or a group CR⁹R¹⁰, CR⁷R⁸CR⁹R¹⁰ or CR⁹R¹⁰CR⁷R⁸ where n is 0, 1 or 2, R⁷ and R⁸ are independently selected from hydrogen, fluoro, or hydrocarbyl, and either one of R⁹ or R¹⁰ is hydrogen and the other is an electron withdrawing group, or R⁹ and R¹⁰ together form an electron withdrawing group, and
R⁴ and R⁵ are independently selected from CH or CR¹¹ where R¹¹ is an electron withdrawing group;
the dotted lines indicate the presence or absence of a bond, X¹ is a group CX²X³ where the dotted line bond to which it is attached is absent and a group CX² where the dotted line bond to which it is attached is present, Y¹ is a group CY²Y³ where the dotted line bond to which it is attached is absent and a group CY² where the dotted line bond to which it is attached is present, and X², X³, Y² and Y³ are independently selected from hydrogen and fluorine;
and R¹ is hydrogen or hydrocarbyl, and Z is an anion of charge m.

13. A solid ionically conductive polymer according to claim 11 where, in the group of sub-formula (I) or (II), X¹ and Y¹ represent CX²X³ and CY²Y³ respectively, the dotted bonds are absent and X², X³, Y² and Y³ are all hydrogen.

14. A solid ionically conductive polymer according to claim 11 wherein the starting material is a compound of structure (III) 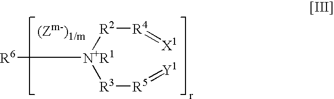
where X¹, Y¹, R², R³, R⁴, R⁵ and the dotted bonds are as defined in claim 11, r is an integer of 1 or more, and R⁶ is a bridging group, an optionally substituted hydrocarbyl group, a perhaloalkyl group, a siloxane group or an amide, of valency r.

15. A solid ionically conductive polymer according to claim 14 wherein the starting material comprises a compound of formula (IV) 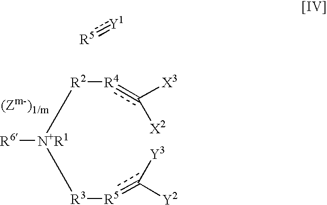
where X², X³, Y², Y³, R², R³, R⁴, and R⁵ are as defined in claim 11, R^{6′} is an optionally substituted hydrocarbyl group, a perhaloalkyl group, a siloxane group or an amide.

16. A solid ionically conductive polymer according to claim 14 in which r is two.

17. A solid ionically conductive polymer according to claim 14 wherein R⁶ or R^{6′} comprises a straight or branched chain alkyl group, optionally substituted or interposed with functional groups.

18. A solid ionically conductive polymer according to claim 14 wherein R⁶ or R^{6′} is an optionally substituted hydrocarbyl group having four or more carbon atoms.

19. A solid ionically conductive polymer according to claim 19 in which R⁶ or R^{6′} is an alkyl group, preferably a straight chain alkyl group.

20. A solid ionically conductive polymer according to claim 18 in which R⁶ or R^{6′} has between five and twenty carbon atoms, preferably between eight and fourteen carbon atoms, most preferably ten carbon atoms.

21. A solid ionically conductive polymer according to claim 20 in which the starting material is a compound of formula (V)

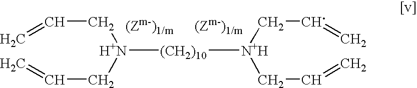

22. A solid ionically conductive polymer according to claim 20 in which R¹ is an alkyl group, preferably having less than three carbon atoms, most preferably methyl.

23. A structure including a substrate and a solid ionically conductive polymer according to claim 1 located therein or thereon.

24. A structure according to claim 23 in which the substrate is porous, and solid ionically conductive polymer is located in the pores of the substrate.

25. A structure according to claim 24 in which the substrate is a ceramic.

26. A structure according to claim 24 in which the substrate is a zeolite.

27. A structure according to claim 23 in the form of an ionically conductive membrane.

28. A method of producing a solid ionically conductive polymer having repeat units of a quaternary ammonium including the steps of polymerising a quaternary ammonium starting material and providing a plasticiser in the polymer present in an amount sufficient to render the polymer non-crystalline thereby increasing conductivity.

29. A method according to claim 28 in which the quaternary ammonium starting material is sprayed onto a target structure prior to the step of polymerising.

30. A method according to claim 28 in which the step of polymerising is effected by the application of radiation, where necessary in the presence of an initiator.

31. A method according to claim 30 in which the polymerisation is effected by the application of ultraviolet radiation.

32. A method according to claim 28 in which the plasticiser is mixed with the starting material prior to the step of polymerising.

33. A method according to claim 28 in which the plasticiser is added to the polymer after or during the step of polymerising.

34. A method of producing a structure including the steps of providing a porous substrate, introducing a quaternary ammonium starting material and a plasticiser into the pores of the substrate, and polymerising the starting material to produce a solid ionically conductive polymer, the plasticiser being present in an amount sufficient to render the polymer non-crystalline thereby increasing conductivity.

35. A fuel cell including a solid ionically conductive polymer according to claim 1.

36. A fuel cell including an ionically conductive membrane according to claim 27.
